(19) United States
(12) Patent Application Publication
(10) Pub. No.: US 2013/0306529 A1
(43) Pub. Date: Nov. 21, 2013

(54) WATER PURIFICATION SYSTEM

(71) Applicants: Tom Flaim, Suwanee, GA (US); Steve Flaim, Marietta, GA (US)

(72) Inventors: Tom Flaim, Suwanee, GA (US); Steve Flaim, Marietta, GA (US)

(21) Appl. No.: 13/896,892

(22) Filed: May 17, 2013

Related U.S. Application Data
(60) Provisional application No. 61/648,334, filed on May 17, 2012.

(51) Int. Cl. C02F 1/30

(52) U.S. Cl. CPC C02F 1/30
USPC 210/85; 210/251

(57) ABSTRACT

Purification of water is obtained by pumping water through a multi-stage filtration unit or a series of filters having increasingly smaller dimensional passages and then irradiating the water using UV light delivered at over 16,000 microwatts/cm²/sec. The system is advantageously portable for use in diverse environments and operable using a variety of power sources from solar to conventional fuels or electricity.

This application claims the benefit of U.S. provisional application Ser. No. 61/648,334, filed May 17, 2012, the subject matter of which is incorporated herein by reference.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention is generally related to a system for purifying water utilizing various stages of prefiltration, filtration and Class “A” or wattage in excess of 16,000 microwatts/cm²/sec ultraviolet irradiation.

### SUMMARY

Embodiments of the present invention provide an apparatus and methods of use thereof for purifying compromised fresh water into potable water. This new treatment train builds upon previous art that incorporated filtration and UV, but utilized low dosage, or Class “B” wattage of 16,000 microwatts/cm²/sec UV. The distinction is significant because of the applicability of the systems of the disclosure for high capacity portable water purification and the incorporation of high dosage UV in the water treatment process, particularly for solar powered water purification systems.

One possible application of this treatment train and process is in a mechanism that features hydraulically communicating chambers containing any variety of filters for particular contaminants in the source water. Once the water passes through the filters, the high capacity UV bulbs can provide a high level of disinfection for large volumes of water not now available in portable systems. High capacity bulbs operate at up to 40,000 microwatts/cm²/sec or more. All current related art for this process embodies Class “B” bulbs that operate at 16,000 microwatts/cm²/sec. High capacity bulbs provide significant functional advantages over Class “B” bulbs. Because of their superior wattage, high capacity bulbs provide superior disinfection versus Class “B” bulbs. Additionally, high capacity technology enables greater volumes of water to be disinfected because of its capacity and wattage strength.

Accordingly, embodiments of the stand-alone integrated water treatment system of the disclosure for generating a potable water supply can comprise a filtration system fluidly connected to a water inlet and comprising a plurality of fluidly connected filtration units, wherein said filtration system is configured to provide water substantially free of particulate material having at least one dimension greater than about 0.01 microns; an ultra-violet light high capacity system fluidly connected to the filtration system; and a power source to operate the water treatment system, whereby water to be treated is directed through said filtration system and is subjected to irradiation by said ultra-violet light high capacity system.

In some embodiments of the water treatment system of the disclosure, the power source can be a connector configured to operably connect the water treatment system to an external power source.

In other embodiments of the water treatment system of the disclosure, the power source can be a power supply system integrated with the water-treatment system.

In yet other embodiments of the water treatment system of the disclosure, the power source is a solar power supply system, a battery system, or a gasoline-powered generator.

In embodiments of the water treatment system of the disclosure, the system can be configured to be transportable. In these embodiments of the water treatment system, the system can be configured to be transportable by air, by a wheeled transport system, by an animal or human, by a flotation system, etc.

In embodiments of the water treatment system of the disclosure, the system can further comprise a pump operably connected to maintain a fluid flow through the water treatment system.

In some embodiments of the water treatment system of the disclosure, the pump can be operably connected to deliver water to the inlet.

In yet other embodiments of the water treatment system of the disclosure, the water treatment system can further comprise a water delivery system operably connected to the inlet.

In embodiments of the water treatment system of the disclosure, the water treatment system can further comprise a water storage container for receiving the water output.

In embodiments of the water treatment system of the disclosure, the ultra-violet light high capacity system can comprise a UV source having a UV output wavelength of between about 200 nm to about 275 nm at between about 3×10⁴ microwatts/cm²/sec and about 5×10⁴ microwatts/cm²/sec.

In embodiments of the water treatment system of the disclosure, the ultra-violet light high capacity system comprises a UV source having an output wavelength of about 254 nm and about 4×10⁴ microwatts/cm²/sec.

In embodiments of the water treatment system of the disclosure, the ultra-violet light high capacity system provides a UV output of more than 16,000 microwatts/cm²/sec that is effective in inactivating bacteria, yeast, algae, mycoplasmas, viruses, or any combination thereof in water received by the ultra-violet light high capacity system from the filtration system.

In embodiments of the water treatment system of the disclosure, the water treatment system can further comprise a UV sensor operably configured to indicate to a water treatment operator that the UV source is not providing UV light energy sufficient to reduce the viability of microorganisms in water.

In some embodiments of the water treatment system of the disclosure, the plurality of filtration units are fluidly connected in series.

In embodiments of the water treatment system of the disclosure, filtration system comprises at least one each of a granular filter unit configured to separate particulate material larger in size than unicellular organisms, a carbon filter unit, and a filter unit configured to provide a water supply substantially free of particulate material having at least one dimension greater than about 2 microns, greater than about 1 micron, greater than about 0.25 microns, greater than about 0.1 microns, greater than about 0.05 microns, or greater than about 0.01 microns, and wherein the filtration units are fluidly connected to progressively size-dependently separate particulate material from a fluid flow.

In embodiments of the water treatment system of the disclosure, at least one filtration unit comprises a filtration bed of alumina hydroxide nanoparticles.

In some embodiments of the water treatment system of the disclosure, the filtration system can comprise a single filtration unit having a plurality of operably connected filtration beds.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 schematically illustrates a water purification system according to the present disclosure.

FIG. 2 is a perspective view of an embodiment of a water purification system according to the present disclosure.

FIG. 3 is a perspective view of an embodiment of a water purification system according to the present disclosure.

FIG. 4 is a perspective view of an embodiment of a water purification system according to the present disclosure.

### DETAILED DESCRIPTION

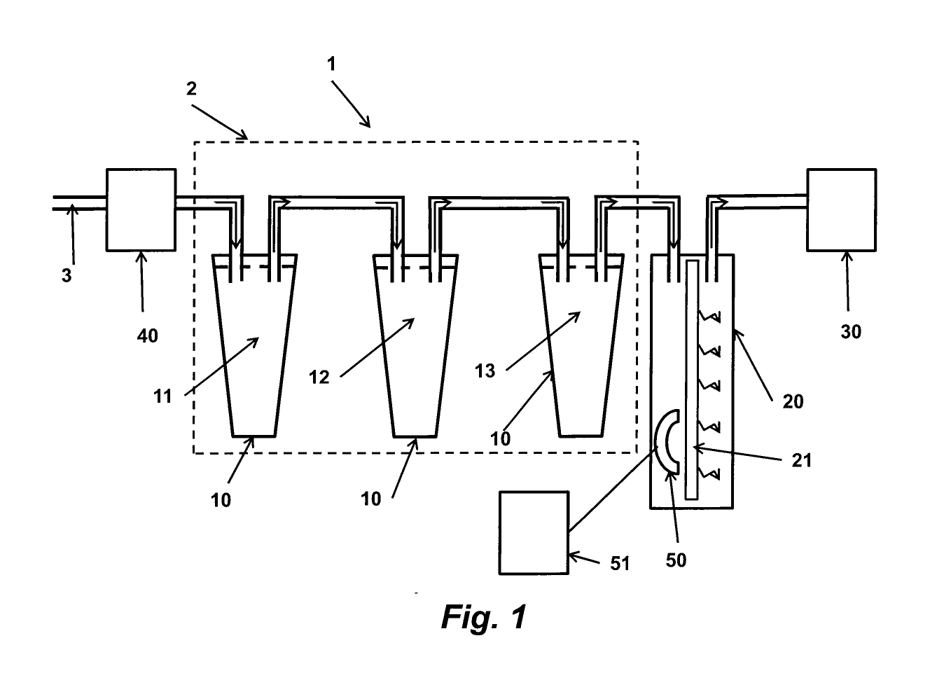

With reference to the drawings, and in particular to FIG. 1, the present disclosure encompasses embodiments of a water treatment system useful for transport to locations deficient in the ability to provide a supply of safe potable water. The water treatment systems may be configured to be transportable by such means as a truck or small mechanical vehicle, a ship or boat, by air, including fixed wing and rotary aircraft, or by human or animal-assisted means. Accordingly, the water treatment systems of the disclosure may also comprise means to increase their transportability including having wheels, skids, handles, lifting means, and the like attached.

It is intended that the systems of the disclosure may be provided to communities that do not currently have access to a reliable and safe source of potable water, such as occurs in developing-world environments. Situations where the water treatment systems of the disclosure may be usefully deployed include where a natural disaster has rendered the existing water supply system inoperable or contaminated, a temporary event requiring potable water but with no access to an existing treated water supply, to satisfy military needs to provide water to deployed or mobile forces, or where the communities do not have a reliable water supply or it has been destroyed. Accordingly, it is understood that the water treatment systems herein disclosed may be configured to be self-contained and independent of ancillary equipment. To this end the systems of the disclosure may include a pump system for delivering water from a water source to the treatment system, and a power supply to power the treatment system in its entirety. While the system may include a means to be enable connection to an independent power source such as an existing electricity system of the location where deployed, an independent power source such as batteries, solar powered systems, gasoline-powered generators, and the like may be included in the self-contained water treatment systems of the disclosure. It is understood also that while a power generating system may be included in the self-contained systems of the disclosure and attached, for example, to a supporting frame that also includes the water filtration and irradiation units, the power generating system may also be a separate unit. For example, the power generating system may be an array of solar panels advantageously deployed over an area selected for optimum solar energy collection and resulting power output to the water treatment units.

With reference now to FIG. 1, the system 1 of the disclosure comprises a filtration system 2 in combination with a UV light sterilization system 20 for the removal of particulate material from a water supply, in particular material of from about 0.01 microns or greater, and the destruction of microorganisms ranging in size from yeast and bacteria to viruses, to provide a source of potable water free of most, if not all, pathogenic and non-pathogenic organisms. In particular, the systems of the disclosure comprise a high capacity UV light source 20 with an energy output of over 16,000 microwatts/cm²/sec, which is significantly greater than the currently used class “B” sources that are more typically about 16,000 microwatts/cm²/sec. This allows for the UV destruction of microorganisms as small as viruses, which are not effectively destroyed by the more typical class “B” UV sources, that could otherwise pose a significant health threat to consumers of the output water.

Embodiments of the water treatment systems of the disclosure, therefore, comprise an inlet 3 for receiving a water flow and fluidly connected to a filtration system 2 for the mechanical removal of particulate, and especially organic material, from the water. The incoming water may be drawn from such as a well, pond, lake, river, community water supply or other available source of fresh, non-salt water. The water may be delivered directly to the water treatment system 1, or indirectly by initial transfer to such as a holding tank, a transporter tank, etc., and may, therefore, have undergone an initial sedimentation storage step to allow particulate matter, debris and the like to settle under gravity before being pumped into the filtration system. The system of the disclosure may include a pump 40 for extracting the water from a source and providing a water flow under pressure sufficient allow the water to pass through the one or more filtration units 10, and a UV light system 20 before exiting the purification system.

One advantageous filtration system 2 of the water treatment system 1 can comprise one or more filter units 10 connected serially, as shown in FIG. 1, or in parallel, and capable of progressively removing particulate material from the water flow, beginning with particles of a size that render them visible and finally removing all but particulate material smaller than about 0.01 microns in size. It is intended that the filtration system 2 be advantageously configured to deliver a water flow to the UV light system 20 that is substantially free of particulate, especially organic particulate material. In the context of the present disclosure, the term “substantially free” as used herein is understood to mean a water stream not having residual particulate or organic material in an amount that decreases the efficacy of an irradiating high capacity UV light system to destroy viruses and other microorganisms and render the water stream fit for human or animal consumption. Accordingly the final filter unit 10 immediately preceding the UV light system 20 preferably removes from the water flow particulate material having at least one dimension greater than about 0.01 microns.

For example, but not intended to be limiting, a first filter unit may be a sediment filter 11 to remove debris and other inert material that could block and interfere with the flow of water through subsequent filter units. A carbon filter 12 may be included in the system to remove organic molecules that can be damaging or toxic to the health of consumers, or would otherwise affect the taste or odor of the output water, thereby rendering the water unacceptable as potable water. In addition, it is contemplated that a filter unit 13, (an “ultrafiltration” unit) capable of removing particles as small as viruses, and the like, be included in the system. Accordingly, this “ultrafiltration” unit advantageously comprises a filtration material selected to retain and prevent the passage through the filtration unit of particles greater than about 0.01 microns, a size that includes many viruses and virus-like particles.

It is understood that any filter material may be used, such as a ceramic filter, a microporous cellulose filter, and the like with the proviso that it is capable of removing particles having a size greater than about 0.01 microns and greater from the water flow. One advantageous type of filter useful for such a purpose, but not intended to be limiting, is a nano alumina hydroxide filter, disclosed, for example, in U.S. Pat. Nos. 6,838,005 and 7,601,262, incorporated herein by reference in their entireties. With this material, the pore sizes of the filter bed may exceed the diameter of the particles desired to be removed from the water flow. However, the electropositive properties of the nano alumina hydroxide filter will attract and bind to electronegative particles including but not limited to, viruses and other organic material.

It is further considered within the scope of the disclosure that an alternative embodiment of the filtration system can be a single filtration unit having a multi-layered filtration bed comprising a plurality of layers of filter mediums. In such a single filtration unit, inflowing water will encounter successive filter layers of decreasing pore size resulting in outflowing water having particulate material of less than about 0.01 microns.

The filter system 2 is disposed in the water flow passing through the water treatment system 1 before the UV light unit 20. This ensures that the amount of organic material in the water flow has been reduced both in particle size to particles of about 0.01 microns or less, and amount to a level that will not absorb the irradiating high capacity UV light to a level whereby the efficiency of the UV source to destroy microorganisms is adversely affected.

The UV light unit 20 of the system 1 herein disclosed is a high capacity source delivering over 16,000 microwatts/cm²/sec and preferably between about 30,000 microwatts/cm²/sec to about 50,000 microwatts/cm²/sec of energy at a wavelength of about 200 nm to about 275 nm. In some preferred embodiments, the UV source delivers about 40,000 microwatts/cm²/sec of energy at a wavelength of about 254 nm. The high capacity UV system may also include a sensor unit 50 electrically connected to a control unit 51 for adjusting the output of the UV-emitting bulb and/or alerting a system operator should the UV emissions fall below a predetermined level, thereby ensuring adequate UV energy emission to destroy undesirable microorganisms or organic matter contaminants in the water flow. Usefully, the UV light source 21 can be electrically sealed to allow immersion of the light source into the water stream, as shown in FIG. 1 for example. However, in other embodiments of the system of the disclosure the UV source may be suspended over, or immersed in a container of the outflow from the filtration system 2 for batch wide sterilization or continuous-flow exposure of the water to the sterilizing radiation.

In operation of the water treatment system 1 of the disclosure, the outflow of water from the UV light unit may be fluidly connected to a water container 30 for storage, or the outlet may be connected to a water distribution system to deliver the water to the consumers or to a holding tank for storage located distantly from the treatment system itself.

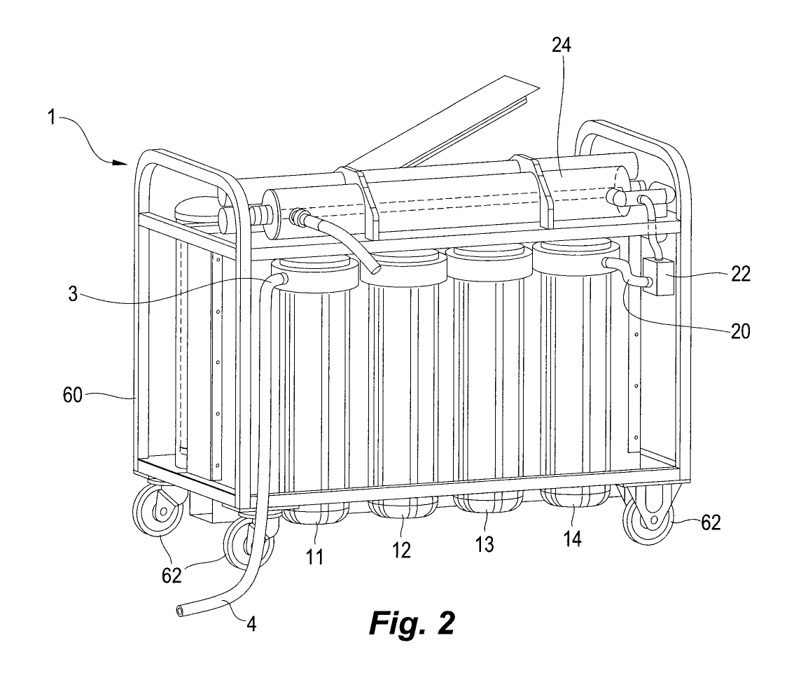

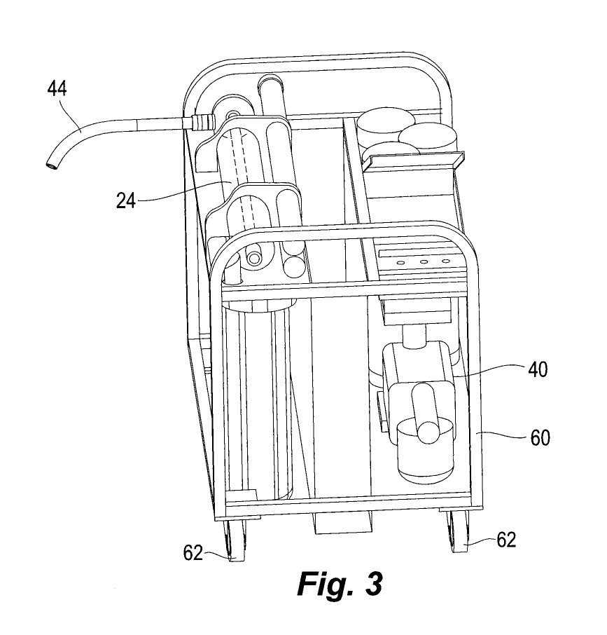

Referring now to FIGS. 2-4, perspective drawings of embodiments of the water purification system of the disclosure are provided. In these embodiments that are not understood to be limiting, the water purification system 1 can be mounted on a frame 60 to provide a single system that does not have to be dismantled for transport. It is contemplated that the frame can be fitted with a transport means such as a plurality of caster wheels 62 that can allow the system to be readily relocated. Other transport means may also be utilized.

Referring to FIGS. 2-4, water to be purified is introduced into the system through inlet 3 which is connected to an inlet hose or conduct 4. The water is pumped through filter unit 11 which is a sediment filter, or a like macro-filtration medium to remove debris and other relatively large, inert, particulates. The water is then pumped through a carbon, or like material, filter 12, to remove organic molecules that are detrimental to human or animal health, and also to remove elements that impart malodor or bad taste to the water.

A third stage filter unit is an ultrafiltration filter unit 13. Contained therein is a filtration material selected to retain and prevent the passage therethrough of particles greater than about 0.01 microns, a size that includes many viruses and virus-like particles. The filter material may be a ceramic filter, a microporous cellulose filter, a nano alumina hydroxide filter, or other suitable material. An additional filter unit 14 may be employed in certain environments or situations as required.

After the water has been pumped through the third-stage ultrafiltration unit 13, and, possibly, a fourth stage unit 14, it exits through outlet 20 and through a UV safety valve 22. From the check valve 22, the water is pumped into a UV light unit 24 where the water is irradiated by UV light energy. The unit delivers energy at over 16,000 microwatts/cm²/sec and can be set to deliver energy at over 50,000 microwatts/cm²/sec. This effectively destroys substantially any remaining hazardous material, thereby rendering the water fit for human or animal consumption.

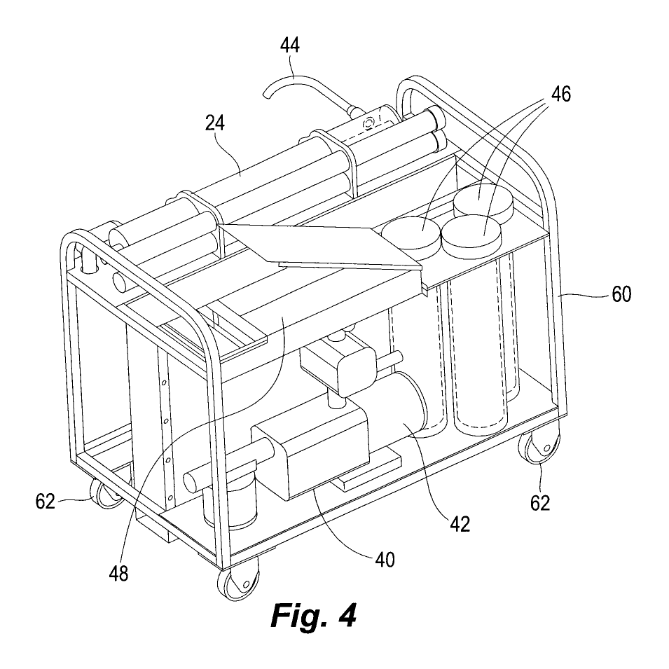

Pump 40 is driven by a motor unit 42, which can be powered by conventional AC power, DC power, batteries, solar energy, gas generators, and other power sources. Electronics to control the workings of the system are conveniently housed in an upper control box 46. After the water has passed through the system 1, it is pumped through outlet 44 for immediate use or to a storage unit (not shown) for future use. Advantageously, spare filter units or cartridges 46, shown in FIG. 4, may be stored within the frame 60, for replacement of the filter units 11-14, or to provide additional means of filtration, depending on the environment in which the system is used.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Accordingly, embodiments of the stand-alone integrated water treatment system of the disclosure for generating a potable water supply can comprise a filtration system fluidly connected to a water inlet and comprising a plurality of fluidly connected filtration units, wherein said filtration system is configured to provide water substantially free of particulate material having at least one dimension greater than about 0.01 microns; an ultra-violet light high capacity system fluidly connected to the filtration system; and a power source to operate the water treatment system, whereby water to be treated is directed through said filtration system and is subjected to irradiation by said ultra-violet light high capacity system.

In some embodiments of the water treatment system of the disclosure, the power source can be a connector configured to operably connect the water treatment system to an external power source.

In other embodiments of the water treatment system of the disclosure, the power source can be a power supply system integrated with the water-treatment system.

In yet other embodiments of the water treatment system of the disclosure, the power source is a solar power supply system, a battery system, or a gasoline-powered generator.

In embodiments of the water treatment system of the disclosure, the system can be configured to be transportable. In these embodiments of the water treatment system, the system can be configured to be transportable by air, by a wheeled transport system, by an animal or human, by a flotation system, etc.

In embodiments of the water treatment system of the disclosure, the system can further comprise a pump operably connected to maintain a fluid flow through the water treatment system.

In some embodiments of the water treatment system of the disclosure, the pump can be operably connected to deliver water to the inlet.

In yet other embodiments of the water treatment system of the disclosure, the water treatment system can further comprise a water delivery system operably connected to the inlet.

In embodiments of the water treatment system of the disclosure, the water treatment system can further comprise a water storage container for receiving the water output.

In embodiments of the water treatment system of the disclosure, the ultra-violet light high capacity system can comprise a UV source having a UV output wavelength of between about 200 nm to about 275 nm at between about 3×10⁴ microwatts/cm²/sec and about 5×10⁴/microwatts/cm²/sec.

In embodiments of the water treatment system of the disclosure, the ultra-violet light high capacity system comprises a UV source having an output wavelength of about 254 nm and about 4×10⁴ microwatts/cm²/sec.

In embodiments of the water treatment system of the disclosure, the ultra-violet light high capacity system provides a UV output effective in inactivating bacteria, yeast, algae, mycoplasmas, viruses, or any combination thereof in water received by the ultra-violet light high capacity system from the filtration system.

In embodiments of the water treatment system of the disclosure, the water treatment system can further comprise a UV sensor operably configured to indicate to a water treatment operator that the UV source is not providing UV light energy sufficient to reduce the viability of microorganisms in water.

In some embodiments of the water treatment system of the disclosure, the plurality of filtration units are fluidly connected in series.

In embodiments of the water treatment system of the disclosure, filtration system comprises at least one each of a granular filter unit configured to separate particulate material larger in size than unicellular organisms, a carbon filter unit, and a filter unit configured to provide a water supply substantially free of particulate material having at least one dimension greater than about 2 microns, greater than about 1 micron, greater than about 0.25 microns, greater than about 0.1 microns, greater than about 0.05 microns, or greater than about 0.01 microns, and wherein the filtration units are fluidly connected to progressively size-dependently separate particulate material from a fluid flow.

In embodiments of the water treatment system of the disclosure, at least one filtration unit comprises a filtration bed of alumina hydroxide nanoparticles.

In some embodiments of the water treatment system of the disclosure, the filtration system can comprise a single filtration unit having a plurality of operably connected filtration beds.

While an embodiment of a water purification system, and modifications thereof, have been shown and described in detail herein, various additional changes and modifications can be made without departing from the scope of the present disclosure.

We claim:

1. A stand-alone integrated water treatment system for generating a potable water supply comprising:
a filtration system fluidly connected to a water inlet and comprising a plurality of fluidly connected filtration units, wherein said filtration system is configured to provide water substantially free of particulate material having at least one dimension greater than about 0.01 microns;
an ultra-violet light high capacity system with wattage in excess of 16,000 microwatts/cm²/sec fluidly connected to the filtration system; and
a power source to operate the water treatment system, whereby water to be treated is directed through said filtration system and the subjected to irradiation by said ultra-violet light high capacity system with wattage in excess of 16,000 microwatts/cm²/sec.

2. The water treatment system of claim 1, wherein power source is a connector configured to operably connect the water treatment system to an external power source.

3. The water treatment system of claim 1, wherein the power source is a power supply system integrated with the water-treatment system.

4. The water treatment system of claim 3, wherein the power source is a solar power supply system, a battery system, or a gasoline-powered generator.

5. The water treatment system of claim 1, wherein the system is configured to be transportable.

6. The water treatment system of claim 1, wherein the system is configured to be transportable by air, by a wheeled transport system, by an animal or human, or by a flotation system.

7. The water treatment system of claim 1, further comprising a pump operably connected to maintain a fluid flow through the water treatment system.

8. The water treatment system of claim 7, wherein the pump is operably connected to deliver water to the inlet.

9. The water treatment system of claim 1, wherein the water treatment system further comprises a water delivery system operably connected to the inlet.

10. The water treatment system of claim 1, further comprising a water storage container for receiving the water output.

11. The water treatment system of claim 1, wherein said ultra-violet light high capacity system with wattage in excess of 16,000 microwatts/cm²/sec comprises a UV source having a UV output wavelength of between about 200 nm to about 275 nm at between about 3×10⁴ microwatts/cm²/sec and about 5×10⁴/microwatts/cm²/sec.

12. The water treatment system of claim 1, wherein the ultra-violet light high capacity system with wattage in excess of 16,000 microwatts/cm²/sec comprises a UV source having an output wavelength of about 254 nm and about 4×10⁴ microwatts/cm²/sec.

13. The water treatment system of claim 1, wherein the ultra-violet light high capacity system provides a UV output of over 16,000 microwatts/cm²/sec effective in inactivating bacteria, yeast, algae, mycoplasmas, viruses, or any combination thereof in water received by the ultra-violet light class “A” system from the filtration system.

14. The water treatment system of claim 1, further comprising a UV sensor operably configured to indicate to a water treatment operator that the UV source is not providing UV light energy sufficient to reduce the viability of microorganisms in water.

15. The water treatment system of claim 1, wherein the plurality of filtration units are fluidly connected in series.

16. The water treatment system of claim 1, wherein the filtration system comprises at least one each of a granular filter unit configured to separate particulate material larger in size than unicellular organisms, a carbon filter unit, and a filter unit configured to provide a water supply substantially free of particulate material having at least one dimension greater than about 2 microns, greater than about 1 micron, greater than about 0.25 microns, greater than about 0.1 microns, greater than about 0.05 microns, or greater than about 0.01 microns, and wherein the filtration units are fluidly connected to progressively size-dependently separate particulate material from a fluid flow.

17. The water treatment system of claim 1, wherein at least one filtration unit comprises a filtration bed of alumina hydroxide nanoparticles configured for electrostatic removal from the water flow of particulate material greater than about 0.01 microns.

18. The water treatment system of claim 1, wherein the filtration system comprises a single filtration unit having a plurality of operably connected filtration beds.
